(19) United States
(12) Patent Application Publication
(10) Pub. No.: US 2026/0116375 A1
(43) Pub. Date: Apr. 30, 2026

(54) SYSTEMS AND METHODS FOR MARSHALING A VEHICLE

(71) Applicant: Ford Global Technologies, LLC, Dearborn, MI (US)

(72) Inventors: Stuart C. Salter, White Lake, MI (US); Krishna Bandi, Novi, MI (US); Mario Anthony Santillo, Canton, MI (US); Brendan Diamond, Naples, FL (US); Vyas Darshan Shenoy, Canton, MI (US)

(73) Assignee: Ford Global Technologies, LLC, Dearborn, MI (US)

(21) Appl. No.: 18/925,722

(22) Filed: Oct. 24, 2024

(51) Int. Cl. B60W 30/06; G05D 1/69; G05D 109/10; H04W 4/021

(52) U.S. Cl. CPC B60W 30/06; G05D 1/69; H04W 4/021; B60W 2556/40; G05D 2109/10

(57) ABSTRACT

A method includes the assignment of one or more vehicles to a zone within one or more geofenced locations, the assignment of a target orientation within the zone to each vehicle of the one or more vehicles, and causing each vehicle of the one or more vehicles to move to a target location within the zone and to be positioned in the target orientation within the target location.

### FIELD

The present disclosure relates to marshaling a vehicle. More specifically, the present disclosure relates to marshaling the vehicle to park in a particular location and in a particular orientation within the particular location.

### BACKGROUND

The statements in this section merely provide background information related to the present disclosure and may not constitute prior art.

Organizing parked vehicles as part of a manufacturing process inherently includes inefficiencies such as unused space left between parked vehicles that otherwise can be used, among other things, for fitting more parked vehicles in a parking lot, for example. Other issues regarding a particular location of where a vehicle should be parked are not able to be considered due to a lack of organizational capacity of present parking systems. The present disclosure addresses these and other issues related to the marshaling of one or more vehicles as part of an automated parking system.

### SUMMARY

This section provides a general summary of the disclosure and is not a comprehensive disclosure of its full scope or all of its features.

The present disclosure provides a method comprising: assigning one or more vehicles to a zone within one or more geofenced locations based on a first set of inputs and a map of an area that includes the one or more geofenced locations; assigning a target orientation within the zone to each vehicle of the one or more vehicles based on a second set of inputs; and causing each vehicle of the one or more vehicles to move to a first target location within the zone, and to be positioned in the target orientation within the first target location; further comprising: identifying the one or more geofenced locations based on one or more locations of interest proximate the one or more geofenced locations, wherein the one or more locations of interest includes a repair bay, a transportation area, an inspection area, an assembly area, a short-term parking area, a long-term parking area, a purchase area, a calibration area, a testing area, or a combination thereof; wherein the second set of inputs includes at least one of an expected interaction with each vehicle of the one or more vehicles, one or more serviceable components of each vehicle of the one or more vehicles, a wheelbase of each vehicle of the one or more vehicles, a turn radius of each vehicle of the one or more vehicles, steering capabilities of each vehicle of the one or more vehicles, the target orientation, or a combination thereof; wherein the first set of inputs includes at least one of a vehicle status, a second target location, one or more vehicle characteristics, a likelihood of the one or more vehicles being damaged, a likelihood of the one or more vehicles being stolen, logistical delivery information for each of the one or more vehicles, or a combination thereof; wherein the vehicle status indicates one or more tasks associated with an assembly of the vehicle, wherein the one or more tasks includes a vehicle repair, a vehicle inspection, a feature calibration, a sensor calibration, an additional component installation, or a combination thereof; further comprising: causing a vehicle of the one or more vehicles to move to the second target location, wherein the second target location is determined based on a dynamic order associated with when the one or more tasks are to be performed on each of the one or more vehicles; and wherein the assignment of the one or more vehicles to the zone is further based on: determining a priority list of the vehicle repair associated with each vehicle of the one or more vehicles; or determining a priority list of the logistical delivery information.

The present disclosure provides a system comprising: a vehicle system configured to: assign one or more vehicles to a zone within one or more geofenced locations based on a first set of inputs and a map of an area that includes the one or more geofenced locations, assign a target orientation within the zone to each vehicle of the one or more vehicles based on a second set of inputs, and cause each vehicle of the one or more vehicles to move to a first target location within the zone, and to be positioned in the target orientation within the first target location; and the one or more vehicles configured to: receive a first set of instructions, from the vehicle system, wherein the first set of instructions cause each vehicle of the one or more vehicles to move to the first target location, and receive a second set of instructions, from the vehicle system, wherein the second set of instructions cause each vehicle of the one or more vehicles to be positioned in the target orientation within the first target location; wherein the vehicle system is further configured to: identify the one or more geofenced locations based on one or more locations of interest proximate the one or more geofenced locations, wherein the one or more locations of interest includes a repair bay, a transportation area, an inspection area, an assembly area, a short-term parking area, a long-term parking area, a purchase area, a calibration area, a testing area, or a combination thereof; wherein the second set of inputs includes at least one of an expected interaction with each vehicle of the one or more vehicles, one or more serviceable components of each vehicle of the one or more vehicles, a wheelbase of each vehicle of the one or more vehicles, a turn radius of each vehicle of the one or more vehicles, steering capabilities of each vehicle of the one or more vehicles, the target orientation, or a combination thereof; wherein the first set of inputs includes at least one of a vehicle status, a second target location, one or more vehicle characteristics, a likelihood of the one or more vehicles being damaged, a likelihood of the one or more vehicles being stolen, logistical delivery information for each of the one or more vehicles, or a combination thereof; wherein the vehicle status indicates one or more tasks associated with an assembly of the vehicle, wherein the one or more tasks includes a vehicle repair, a vehicle inspection, a feature calibration, a sensor calibration, an additional component installation, or a combination thereof; wherein the vehicle system is further configured to: cause a vehicle of the one or more vehicles to move to the second target location, wherein the second target location is determined based on a dynamic order associated with when the one or more tasks are to be performed on each of the one or more vehicles; and wherein the vehicle system configured to assign the one or more vehicles to the zone is further configured to: determine a priority list of the vehicle repair associated with each vehicle of the one or more vehicles; or determine a priority list of the logistical delivery information.

The present disclosure provides one or more non-transitory computer-readable media storing processor-executable instructions that, when executed by at least one processor, cause the at least one processor to: assign one or more vehicles to a zone within one or more geofenced locations based on a first set of inputs and a map of an area that includes the one or more geofenced locations; assign a target orientation within the zone to each vehicle of the one or more vehicles based on a second set of inputs; and cause each vehicle of the one or more vehicles to move to a first target location within the zone, and to be positioned in the target orientation within the first target location; wherein the at least one processor is further caused to: identify the one or more geofenced locations based on one or more locations of interest proximate the one or more geofenced locations, wherein the one or more locations of interest includes a repair bay, a transportation area, an inspection area, an assembly area, a short-term parking area, a long-term parking area, a purchase area, a calibration area, a testing area, or a combination thereof; wherein the second set of inputs includes at least one of an expected interaction with each vehicle of the one or more vehicles, one or more serviceable components of each vehicle of the one or more vehicles, a wheelbase of each vehicle of the one or more vehicles, a turn radius of each vehicle of the one or more vehicles, steering capabilities of each vehicle of the one or more vehicles, the target orientation, or a combination thereof; wherein the first set of inputs includes at least one of a vehicle status, a second target location, one or more vehicle characteristics, a likelihood of the one or more vehicles being damaged, a likelihood of the one or more vehicles being stolen, logistical delivery information for each of the one or more vehicles, or a combination thereof; wherein the vehicle status indicates one or more tasks associated with an assembly of the vehicle, wherein the one or more tasks includes a vehicle repair, a vehicle inspection, a feature calibration, a sensor calibration, an additional component installation, or a combination thereof; and wherein the at least one processor is further caused to: cause a vehicle of the one or more vehicles to move to the second target location, wherein the second target location is determined based on a dynamic order associated with when the one or more tasks are to be performed on each of the one or more vehicles.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a system for automated vehicle marshaling in accordance with one or more embodiments of the present disclosure;

FIG. 2 illustrates an example vehicle marshaled by the system shown in FIG. 1 in accordance with one or more embodiments of the present disclosure;

FIG. 3 illustrates an example parking environment in accordance with one or more embodiments of the present disclosure;

FIG. 4 is a flowchart illustrating an example method for marshaling a vehicle in accordance with one or more embodiments of the present disclosure; and

FIG. 5 is a block diagram illustrating an example computer system in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One or more examples provides a means for providing a parking system to manage or control a parking process to, for example, optimize the parking of one or more vehicles by marshaling the one or more vehicles based on one or more considerations as is described herein. In one or more embodiments, the parking system is configured to pre-sort the one or more vehicles into specific areas so that repairs may be easily made in-between other parked vehicles. In one or more embodiments, the parking system is also configured to optimize spacing between parked vehicles to accommodate a need for a human operator to access a particular vehicle at some point in time, which saves overall space in a parking area. In one or more embodiments, the parking system is further configured to determine a value of a vehicle and park higher value vehicles in more secure parking areas.

In one or more embodiments, the parking system is additionally configured to consider a wheelbase of particular vehicles to optimize parking so that vehicles with similar wheelbases are grouped together and are thereby more easily maneuverable. In one or more embodiments, the parking system is also configured to leave space at the front and/or back of parked vehicles so that the vehicles can move within the parking location to prevent flat spots that may affect one or more tires in long term storage. In one or more embodiments, the parking system is configured to consider content of parked vehicles so that human operators may easily locate particular vehicles that are outfitted with special equipment that may be necessary for certain tasks.

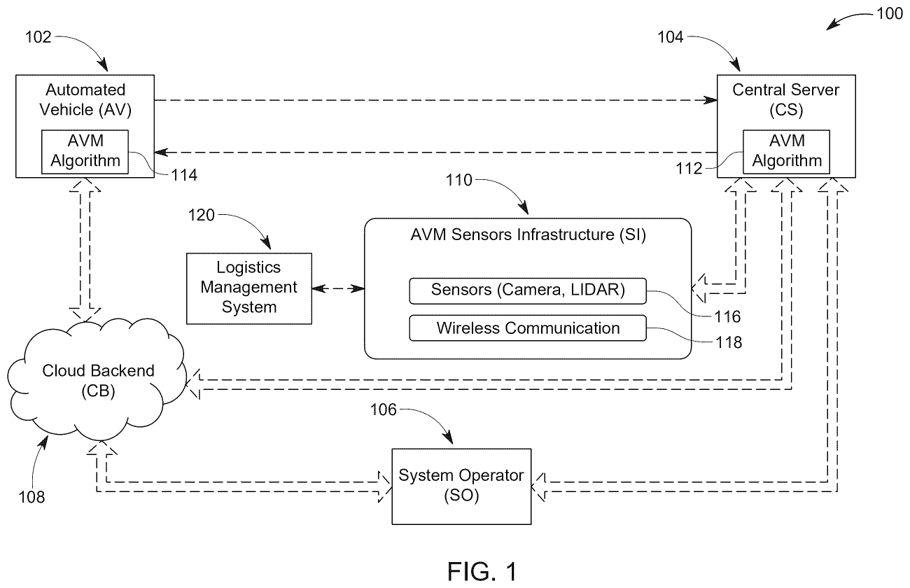

FIG. 1 shows a schematic block diagram illustrative of an automated vehicle marshaling (AVM) system 100. In one or more examples, the AVM system 100 marshals one or more vehicles (e.g., a vehicle 102) traveling at a low speed. However, it is understood that the AVM system 100 may marshal the one or more vehicles traveling at any speed. It is also understood that the AVM system 100 may marshal semi-autonomous vehicles and/or fully autonomous vehicles.

The AVM system 100 generally includes the vehicle 102, a central server 104, a system operator 106, a cloud system 108, and an infrastructure system 110. The central server 104 operates as a central point of communication related to the AVM system 100 and manages and/or facilitates any manufacturing process associated with the vehicle 102. For example, the central server 104 facilitates marshaling of the one or more vehicles, which causes the one or more vehicles to travel through (e.g., traverse) a marshaling environment (e.g., a factory floor or parking lot).

The central server 104 is configured to wirelessly communicate directly with each of the components of the AVM system 100 (e.g., the vehicle 102, the system operator 106, the cloud system 108, and the infrastructure system 110) and can include an infrastructure-side AVM algorithm 112. The central server 104 is also configured to provide logical interface information received from the infrastructure system 110 to the vehicle 102. Additionally, the central server 104 is configured to calculate one or more maneuvers (e.g., movements) associated with the vehicle 102.

The infrastructure-side AVM algorithm 112 processes status information associated with at least the vehicle 102 of the one or more vehicles. It is understood that the infrastructure-side AVM algorithm 112 processes status information associated with each vehicle of the one or more vehicles. The central server 104 is configured to utilize the infrastructure-side AVM algorithm 112 to transmit one or more instructions and/or process information received from each of the components of the AVM system 100 (e.g., the vehicle 102, the system operator 106, the cloud system 108, and the infrastructure system 110). For example, the received information can be related to, but is not limited to, marshaling the vehicle 102 and/or visual based communication with the vehicle 102.

Particularly, based on the direct communication with the one or more vehicles, the central server 104 is further configured to cause the one or more vehicles to start, stop (e.g., at a particular parking location), or pause progression through the marshaling environment. The central server 104 is further configured to control a marshaling speed of the one or more vehicles as the one or more vehicles travel through the marshaling environment.

The vehicle 102 includes a vehicle-side AVM algorithm 114. In one or more embodiments, the vehicle 102 utilizes the vehicle-side AVM algorithm 114 to process and send information gathered by one or more components associated with the construct of the vehicle 102, such as a component internally and/or externally disposed related to the vehicle 102. For example, although not shown, the components associated with the construct of the vehicle 102 can include a wireless transmission module, a vehicle central gateway module, a vehicle infotainment system, one or more vehicle sensors, a vehicle battery, a vehicle global navigation satellite (e.g., GNSS), a vehicle navigation mapping system, and/or a controller area network (CAN) vehicle bus. It is understood that marshaling of the vehicle 102 within the AVM system 100 can be supported by the utilization of any of the one or more components associated with the construct of the vehicle 102.

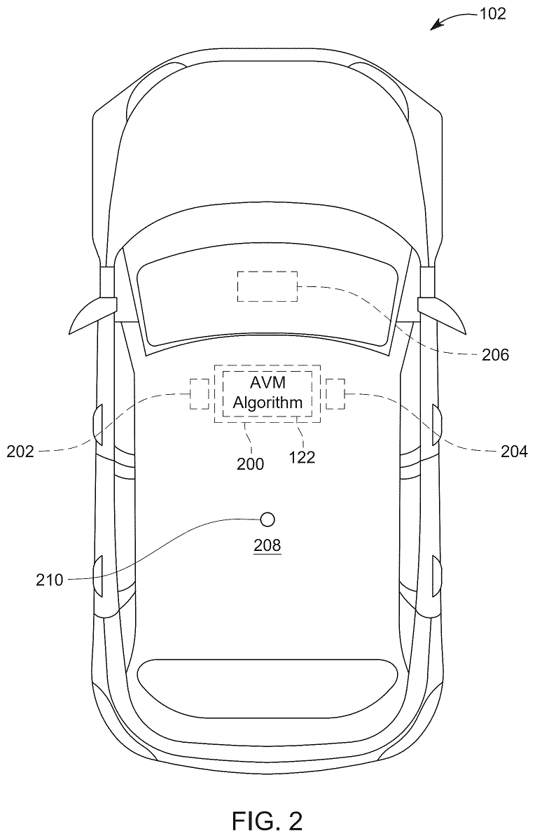

More particularly, and with reference to FIG. 2, in various forms, the vehicle(s) 102 may be powered in a variety of ways, for example, with an electric motor and/or an internal combustion engine. It is understood that the vehicle(s) 102 may be any type of vehicle powered by an electric motor and/or an internal combustion engine such as a car, a truck, a robot, a plane, and/or a boat. The vehicle(s) 102 generally include the vehicle controller 200, one or more actuators 202, a plurality of on-board sensors 204, a human machine interface (HMI) 206, and a vehicle system 208. The vehicle(s) 102 also has a reference point 210, that is, a specified point within a space defined by a vehicle body that identifies the location of the vehicle(s) 102. For example, the reference point 210 is a geometrical center point at which respective longitudinal and lateral center axes of the vehicle(s) 102 intersects. As another example, the reference point 210 is a point at which the vehicle(s) 102 is located as the vehicle(s) 102 navigates toward a waypoint, such as to park the vehicle 102.

The vehicle controller 200, in some examples, is configured or programmed to control the operation of one or more of vehicle brakes, propulsion (e.g., control of acceleration in the vehicle(s) 102 by controlling one or more of an internal combustion engine, electric motor, hybrid engine, etc.), steering, climate control, interior and/or exterior lights, etc. The vehicle controller 200, in other examples, is further configured or programed to determine whether and when the vehicle controller 200, as opposed to a human operator, is to control such operations related to the vehicle(s) 102. It is understood that any of the operations associated with the vehicle(s) 102 may be facilitated via an automated, a semi-automated, or a manual mode. For example, the automated mode may facilitate any of the operations to be fully controlled by the vehicle controller 200 without the aid of the human operator. As another example, the semi-automated mode may facilitate any of the operations to be at least partially controlled by the human operator in combination with the vehicle controller 200. As a further example, the manual mode may facilitate the operations to be fully controlled by the human operator without the aid of the vehicle controller 200.

The vehicle controller 200 includes, or may be communicatively coupled to (e.g., via a vehicle communications bus), one or more processors (not shown). For example, the one or more processors can be a controller, or the like, included in the vehicle(s) 102 for monitoring and/or controlling various vehicle controllers, such as a powertrain controller, a brake controller, a steering controller, etc. The vehicle controller 200 is generally arranged for communications on a vehicle communication network (not shown) that can include a bus in the vehicle(s) 102 such as a CAN bus, or the like, and/or other wired and/or wireless mechanisms.

Via a vehicle network, the vehicle controller 200 transmits messages to various devices in the vehicle(s) 102 and/or receives messages from the various devices, for example, the one or more actuators 202, the HMI 206, etc. Alternatively, or additionally, in cases where the vehicle controller 200 includes multiple devices, the vehicle communication network is utilized for communications between devices represented as the vehicle controller 200 in this disclosure. Further, as discussed below, various other controllers and/or sensors provide data to the vehicle controller 200 via the vehicle communication network.

In addition, the vehicle controller 200, via the vehicle-side AVM algorithm 114, is configured for communicating through a vehicle-to-infrastructure communication network, such as communicating with an infrastructure controller (not shown). The vehicle controller 200, via the vehicle-side AVM algorithm 114, is also configured for communicating through a wireless vehicular communication interface with other traffic objects (e.g., vehicles, infrastructures, etc.), such as, via a vehicle-to-vehicle communication network. The vehicular communication network represents one or more mechanisms by which the vehicle controller 200 of the vehicle(s) 102 communicates with other traffic objects. As an example, the vehicular communication network may be one or more of wireless communication mechanisms, including any desired combination of wireless (e.g., cellular, wireless, satellite, microwave, and/or radio frequency) communication mechanisms and any desired network topology (or topologies when multiple communication mechanisms are utilized). Examples of vehicular communication networks include, among others, cellular, Bluetooth®, IEEE 802.11, dedicated short range communications (DSRC), and/or wide area networks (WAN), including the Internet, providing data communication services.

The one or more actuators 202 are implemented via circuits, chips, or other electronic and/or mechanical components that can actuate various vehicle subsystems in accordance with appropriate control signals. The one or more actuators 202 may be used to control braking, acceleration, and/or steering of the vehicle(s) 102. The vehicle controller 200 can be programmed to activate the one or more actuators 202 including propulsion, steering, and/or braking based on the planned acceleration or deceleration of the vehicle(s) 102.

The plurality of on-board sensors 204 include a variety of devices to provide data to the vehicle controller 200. For example, the plurality of on-board sensors 204 may include object detection sensors (e.g., lidar sensor(s)) disposed on or in the vehicle(s) 102 that provide relative locations, sizes, and/or shapes of one or more objects surrounding the vehicle(s) 102, such as additional vehicles, bicycles, robots, drones, etc., travelling next to, ahead, and/or behind the vehicle(s) 102. As another example, one or more of the plurality of on-board sensors 204 can be radar sensors affixed to one or more bumpers of the vehicle(s) 102 that may provide locations of the object(s) relative to the location of each of the vehicles 102.

The plurality of on-board sensors 204 may include a camera sensor, for example, to provide a front view, side view, rear view, etc., providing images from an area surrounding the vehicle(s) 102. As another example, the vehicle controller 200 may be programmed to receive sensor data from a camera sensor(s) and to implement image processing techniques to detect a road, infrastructure elements, etc. The vehicle controller 200 may be further programmed to determine a current vehicle location based on location coordinates (e.g., GPS coordinates) received from the vehicle(s) 102 indicative of a location of the vehicle 102 determined from a GPS sensor (not shown).

The HMI 206 is configured to receive information from the human operator during operation of the vehicle(s) 102. Moreover, the HMI 206 is configured to present information to the human operator, such as, an occupant of the vehicle(s) 102. In some variations, the vehicle controller 200 is programmed to receive destination data (e.g., location coordinates) from the HMI 206.

The vehicle system 208 is configured to control each of the subsystems within the vehicle(s) 102 and facilitate requests across each of the above-described components (e.g., the vehicle controller 200, the one or more actuators 202, the plurality of on-board sensors 204, and/or the HMI 206). Accordingly, the vehicle(s) 102 can be autonomously guided toward a waypoint using at least the plurality of on-board sensors 204. Routing can be performed using vehicle location, distance to travel, queue in line for vehicle marshaling, etc.

Referring back to FIG. 1, and in one or more embodiments, in addition to or in alternative to the infrastructure system 110, the vehicle-side AVM algorithm 114 may determine the status information associated with the vehicle 102 based on processed information as is further described herein. In another one or more embodiments, the vehicle 102 utilizes the vehicle-side AVM algorithm 114 to process and send information obtained from any of the components associated with the construct of the vehicle 102 to the central server 104, and/or the cloud system 108. However, it is understood that the vehicle 102 can utilize the vehicle-side AVM algorithm 114 to process and send information obtained from any of the components associated with the construct of the vehicle 102 directly to the infrastructure system 110 and/or the system operator 106. Additionally, the vehicle-side AVM algorithm 114 is further configured to process and send information received from any of the components of the AVM system 100 to any of the components associated with the construct of the vehicle 102.

The central server 104 is configured to cause the infrastructure system 110 to monitor the progression of the one or more vehicles as the vehicle(s) move through the marshaling environment. The infrastructure system 110 includes a sensor component 116 and a wireless communication component 118. For example, the wireless communication component 118 may utilize GPS, Wi-Fi, satellite, 3G/4G/5G, and/or Bluetooth™ to communicate with the one or more vehicles. It is understood that by utilizing either of the sensor component 116 and/or the wireless communication component 118, the infrastructure system 110 is configured to perform localization function(s) associated with the marshaling of the vehicle 102, such as, but not limited to, perception, path-planning, detection, controls, response of the vehicle 102, or a combination thereof, among others.

The wireless communication component 118 communicates with the sensor component 116 that is configured to manage, for example, one or more of cameras, lidar, radar, and/or ultrasonic devices. The sensor component 116 monitors the movement of the one or more vehicles as the one or more vehicles are marshaled through the marshaling environment.

The system operator 106 can be a human operator tasked with monitoring the marshaled one or more vehicles by communicating with the cloud system 108. It is understood that the cloud system 108 is a backend system that may represent an original equipment manufacturer cloud system responsible for remote engagement and/or disengagement of AVM application(s) including enrollment and/or unenrollment of the vehicle 102 from the AVM system 100. In one or more embodiments, the system operator 106 communicates with the cloud system 108 and/or monitors the one or more vehicles via a user device (not shown) and/or a human eye of the human operator. However, it is understood that the system operator 106 can also be a non-human operator, such as a mainframe controller, a machine-learning based control system, or any neural network. It is also understood that the system operator 106 is tasked with managing and/or supervising operation of the vehicle 102 (e.g., via an in-facility interface) during automated marshaling, an onboarding process, and/or at individual locations. The system operator 106 is able to receive instructions from the central server 104 and forward those instructions on to the one or more vehicles, via the cloud system 108. For example, the instructions received from the central server 104 can be one or more marshaling commands that can cause the one or more vehicles to travel to a vehicle repair bay, a parking location, a future location, or any other location.

In one or more embodiments, the system operator 106 can obtain information associated with the operation of the vehicle 102. In one or more embodiments, the obtained information can be displayed on the user device based on one or more determinations made by a logistics management system 120 regarding parking the vehicle 102 within the marshaling environment. For example, the user device can be a tablet or any other suitable electronic device. As another example, the one or more determinations are made by utilizing at least the sensor component 116 of the infrastructure system 110 and/or the plurality of on-board sensors 204. In another one or more embodiments, the infrastructure system 110 is configured to communicate (e.g., via a wireless or a wired means) with the logistics management system 120. While the logistics management system 120 is depicted as externally disposed from the infrastructure system 110, it is understood that the logistics management system 120 can be internally disposed within the infrastructure system 110.

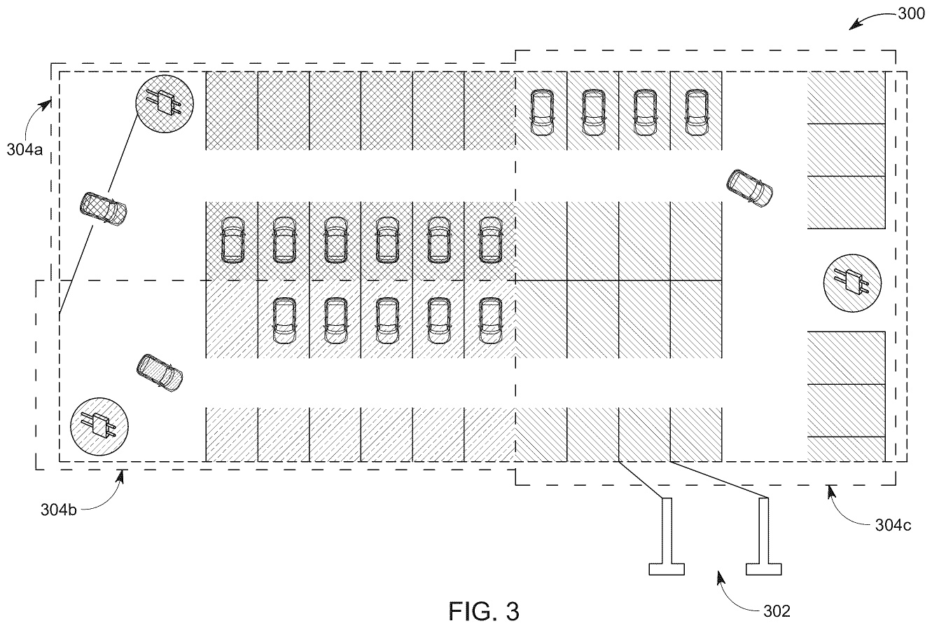

In one or more embodiments, and additionally in consideration of the illustration provided in FIG. 3 that depicts a virtual rendition (e.g., a digital twin) of a manufacturing facility, the logistics management system 120 is configured to facilitate marshaling of the one or more vehicles to a particular parking location 302 within a zone of one or more zones 304a-304c as is described herein. It is understood that a display 300 depicting the virtual rendition of the manufacturing facility can display any number of parking locations (e.g., a parking spot or a target location) within any number of zones. As an example, the virtual rendition of the manufacturing facility may categorize each of the parking locations within the zones 304a-304c in a color coded manner so that the one or more zones 304a-304c can be easily noticed and/or to highlight a particular vehicle amongst many vehicles. As another example, the virtual rendition of the manufacturing facility may highlight the one or more vehicles based on the assignment of the vehicle(s) to a particular parking location in a color coded manner so that a color code identifying a particular vehicle matches a color code of the assigned parking location associated with the particular vehicle.

In an example, the logistics management system 120 is configured to identify each zone of the one or more zones 304a-304c based on a map of the marshaling environment. As another example, the map of the marshaling environment can be stored in a database (not shown) associated with the logistics management system 120. It is understood that the database associated with the logistics management system 120 can be internally disposed within the logistics management system 120 or externally disposed from the logistics management system 120. As yet another example, the logistics management system 120 is also configured to identify each zone of the one or more zones 304a-304c based on one or more user inputs that may be received from the system operator 106 or any other component of the AVM system 100 in addition to, or as an alternative to, the map of the marshaling environment. As an additional example, the logistics management system 120 is further configured to identify each zone of the one or more zones 304a-304c based on input from either of the sensor component 116 of the infrastructure system 110 and/or the plurality of on-board sensors 204 in addition to, or as an alternative to, the map of the marshaling environment and/or the user input.

In one or more embodiments, the vehicle-side AVM algorithm 114 and/or the infrastructure-side AVM algorithm 112 are configured to generate (e.g., create) a geofenced area associated with each zone of the one or more zones 304a-304c. For example, the geofenced area associated with each zone of the one or more zones 304a-304c is a virtual dynamic radio-frequency-based boundary. As another example, the geofenced area associated with each zone of the one or more zones 304a-304c is a dynamic virtual geo-zone of an operational zone associated with the marshaling environment. As yet another example, the vehicle-side AVM algorithm 114 and/or the infrastructure-side AVM algorithm 112 utilizes GNSS and/or radio-frequency-based wireless communication(s) to generate the geofenced area associated with each zone of the one or more zones 304a-304c.

In one or more embodiments, the logistics management system 120 is also configured to assign the vehicle 102 (e.g., and/or any of the one or more vehicles) to a particular zone (e.g., the zone 304c) of the one or more zones 304a-304c. In an example, the assignment of the vehicle 102 to the zone 304c can be based on a location of the zone 304c relative to a location of interest. For example, the location of interest can be a repair bay, a transportation area, an inspection area, an assembly area, a short-term parking area, a long-term parking area, a purchase area, a calibration area, a testing area, any other type of workstation associated with the marshaling environment or a combination thereof. As an example, the vehicle 102 can be assigned to the zone 304c at any time, such as at various points in a manufacturing process.

As yet another example, the assignment of the vehicle 102 to the zone 304c can be based on the status information of the vehicle 102. In an example, the status information can indicate what tasks, if any, should be performed on the vehicle 102. More specifically, the status information can indicate a vehicle repair, a vehicle inspection, a feature calibration, a sensor calibration, an additional component installation, or a combination thereof. While the task(s) should be performed before the vehicle 102 is marshaled to a subsequent location (e.g., a subsequent workstation of the manufacturing facility or shipped to a customer), the task(s) can be performed at any time.

The assignment of the vehicle 102 to the zone 304c can also be based on, for example, a priority associated with the status information. As an example, the vehicle-side AVM algorithm 114 and/or the infrastructure-side AVM algorithm 112 can determine a priority listing associated with the status information (e.g., such as a priority of repair completion or a priority of shipment of the vehicle 102).

In one or more embodiments, each of the one or more zones 304a-304c can include any number of parking locations (e.g., a parking spot or a target location). For example, the assignment of the vehicle 102 to the zone 304c is dynamic. In other words, the assignment of the vehicle 102 to a first parking location within the zone 304c can be changed to a second parking location within the zone 304c based on a change relative to an order (e.g., a chronological order) associated with the priority listing. As an example, the second parking location can be, but is not limited to, a more secure location and/or a location closer to the location of interest. As another example, the assignment of the vehicle 102 to a first parking location within the zone 304c can be changed to a second parking location within a different zone, such as the zone 304a or the zone 304c.

In one or more other embodiments, the assignment of the vehicle 102 to a particular parking location can be based on a second parking location, one or more characteristics of the vehicle 102, a likelihood of the vehicle 102 being damaged, a likelihood of the vehicle 102 being stolen, logistical delivery information for the vehicle 102, or a combination thereof. For example, the vehicle 102 can be assigned to an enclosed parking location or an un-enclosed parking location based on the weather (e.g., if it is raining, the vehicle 102 can be parked in an enclosed parking location). As another example, the one or more vehicle characteristics can include, but is not limited to, a serial number of the vehicle 102, a vehicle trim of the vehicle 102, and/or any specific features (e.g., a diesel engine versus a gasoline engine) associated with the vehicle 102. As another example, the logistical delivery information can include details pertaining to what means will be used to deliver the vehicle 102 to a location, such as a car, a boat, a train, a truck, etc.

In one or more embodiments, the logistics management system 120 is further configured to assign the vehicle 102 (e.g., and/or any of the one or more vehicles) to a particular parking orientation (e.g., a target orientation) within a particular zone (e.g., the zone 304c) of the one or more zones 304a-304c. For example, the assigned parking orientation instructs the vehicle 102 to park in a particular orientation in the parking location 302. In an example, the assignment of the vehicle 102 to the particular parking orientation can be based on at least one of an expected interaction with the vehicle 102, one or more serviceable components of the vehicle 102, a wheelbase of the vehicle 102, a turn radius of the vehicle 102, steering capabilities of the vehicle 102, or a combination thereof. For example, the expected interaction with the vehicle 102 can include a human operator expected to drive the vehicle 102 to a second location or the vehicle 102 autonomously driving to the second location. As another example, the one or more serviceable components of the vehicle 102 can indicate a clearance around the vehicle 102 that will allow for the one or more components to be repaired. As yet another example, the orientation of the vehicle 102 can provide for space around the vehicle 102 that will allow the vehicle 102 to adjust a positioning of the vehicle 102 so as to mitigate any possible flat spots in one or more tires (not shown) of the vehicle 102 over time. It should be understood that the particular orientation for the vehicle 102 can refer to any positional or directional parking aspects relating to the vehicle 102 such as a vertical and/or a horizontal disposition of the vehicle 102.

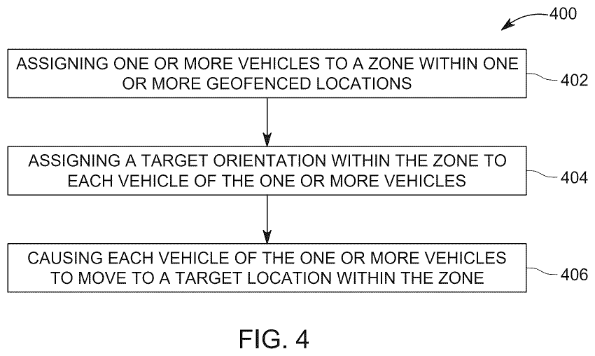

FIG. 4 is a flowchart illustrating an example method 400 for marshaling a vehicle (e.g., the vehicle 102) to optimize one or more needs of a marshaling environment. At operation 402, one or more vehicles is assigned to a zone (e.g., a zone of the one or more zones 304a-304c) within one or more geofenced areas (e.g., associated with the zone). For example, the assignment of the one or more vehicles to the zone is based on a first set of inputs and/or a map of an area (e.g., a map of the marshaling environment). As another example, the area includes the one or more geofenced locations. As an example, the first set of inputs includes at least one of a vehicle status, a second target location, one or more vehicle characteristics, a likelihood of the one or more vehicles being damaged, a likelihood of the one or more vehicles being stolen, logistical delivery information for each of the one or more vehicles, or a combination thereof.

As yet another example, the vehicle status indicates one or more tasks associated with an assembly of the vehicle, wherein the one or more tasks includes a vehicle repair, a vehicle inspection, a feature calibration, a sensor calibration, an additional component installation, or a combination thereof. In one or more embodiments, the vehicle of the one or more vehicles is caused to move to the second target location. For example, the second target location is determined based on a dynamic order associated with when the one or more tasks are to be performed on each of the one or more vehicles. In one or more embodiments, the assignment of the one or more vehicles to the zone is further based on a determination of a priority list of the vehicle repair associated with each vehicle of the one or more vehicles and/or a determination of a priority list of the logistical delivery information.

At operation 404, a target orientation within the zone is assigned to each vehicle of the one or more vehicles. For example, the target orientation is assigned to each vehicle of the one or more vehicles based on a second set of inputs. As another example, the second set of inputs includes at least one of an expected interaction with each vehicle of the one or more vehicles, one or more serviceable components of each vehicle of the one or more vehicles, a wheelbase of each vehicle of the one or more vehicles, a turn radius of each vehicle of the one or more vehicles, steering capabilities of each vehicle of the one or more vehicles, the target orientation, or a combination thereof.

At operation 406, each vehicle of the one or more vehicles is caused to move to a first target location (e.g., the parking location 302) within the zone and/or be positioned in the target orientation within the first target location. In one or more embodiments, the one or more geofenced locations is identified. For example, the one or more geofenced locations is identified based on one or more locations of interest proximate the one or more geofenced locations. As another example, the one or more locations of interest includes a repair bay, a transportation area, an inspection area, an assembly area, a short-term parking area, a long-term parking area, a purchase area, a calibration area, a testing area, or a combination thereof.

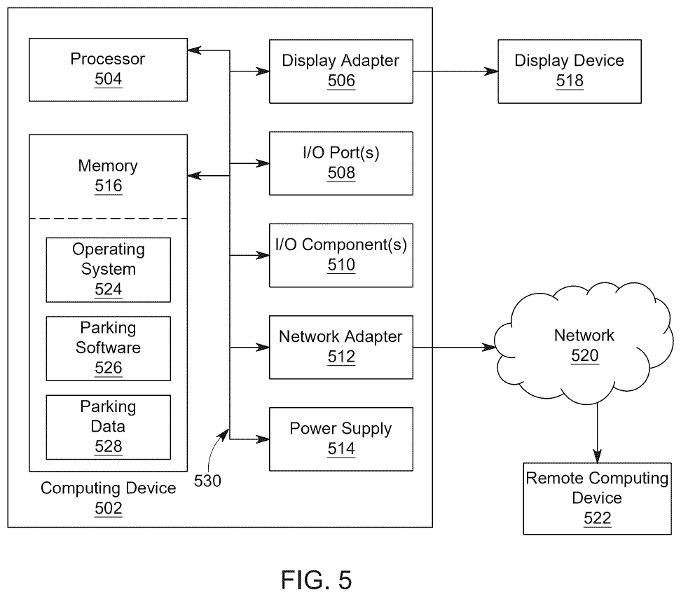

FIG. 5 illustrates an operating environment that facilitates the performance of the one or more systems and methods described herein. More specifically, the systems and methods described herein can be implemented using a computing device 502. For example, the computing device 502 can be a personal computer, a desktop, a laptop, a tablet, a hand-held computer, a server, a workstation, a mainframe, a wearable computer, a supercomputer, or a combination thereof. However, it is understood that the aforementioned examples of the computing device 502 is non-exhaustive and the computing device 502 can be any type of processing or computing device. The computing device 502 generally includes a processor 504, a display adapter 506, one or more input/output port(s) 508, one or more input/output component(s) 510, a network adapter 512, a power supply 514, and a memory 516. However, it is understood that the computing device 502 can include any additional components therein and is not required to include any of the listed components (e.g., the processor 504, the display adapter 506, the one or more input/output port(s) 508, the one or more input/output component(s) 510, the network adapter 512, the power supply 514, and the memory 516).

The processor 504 is configured to provide instructions to the computing device 502 so that the computing device 502 can process one or more tasks including the implementation of a software program to perform one or more operations as described in more detail herein. It is also understood that the computing device 502 may include any number or processors 504 therein. The display adapter 506 can be a graphics card or a video board that provides the computing device 502 with a capability to display content on a display device 518. For example, the display device 518 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of the display device 518 is non-exhaustive and that the display device 518 can be any type of device capable of providing a visual display.

The input/output port(s) 508 provide a number of interfaces (e.g., sockets) for one or more cables to connect to the computing device 502. It is understood that there may be any number of input/output port(s) 508 on the computing device 502. For example, the input/output port(s) 508 provides a means for the computing device 502 to receive signals and/or data from an external device connected to the computing device 502 via the one or more cables. As another example, the input/output port(s) 508 provide a means for the computing device 502 to send signals and/or data to an external device connected to the computing device 502 via the one or more cables. The input/output component(s) 510 can include one or more components that support the input/output port(s) 508 such as, but not limited to, a switch, a push button, a pressure mat, a float switch, a keypad, a radio receive, or a combination thereof.

The network adapter 512 can be any type of network interface controller that is configured to provide a means for communicating over a network 520 with another computing device, such as a remote computing device 522. For example, the remote computing device 522 can be a user device such as a cellular-phone, a smartphone, a tablet, a laptop, or a combination thereof. The power supply 514 is configured to convert alternating high voltage current (e.g., AC) into direct current (e.g., DC) to provide power to the other components (e.g., the processor 504, the display adapter 506, the one or more input/output port(s) 508, the one or more input/output component(s) 510, the network adapter 512, and the memory 516) of the computing device 502.

Additionally, the memory 516 can be a mass storage device and/or a system memory such as a hard disk drive, a memory card, a solid-state drive, random access memory (RAM), or a combination thereof. The memory 516 is configured to provide storage for instructions and data associated with the operation of the computing device 502. The memory 516 can generally include an operating system 524, parking software 526, and parking data 528. For example, the operating system 524 is configured to manage and/or process any of the data and/or instructions associated with the parking software 526 and/or parking data 528, as described in more detail herein.

Furthermore, a system bus 530 is also included within the computing device 502 that is configured to couple each of the various components (e.g., the processor 504, the display adapter 506, the one or more input/output port(s) 508, the one or more input/output component(s) 510, the network adapter 512, the power supply 514, and the memory 516) of the computing device 502. It is also understood that each of the components of the computing device 502, and the functionality associated with each of the components of the computing device 502, may be implemented within the remote computing device 522. While the operating environment illustrated within FIG. 5 depicts a particular configuration associated with at least the computing device 502, the network 520, and the remote computing device 522, it is understood that the operating environment may be configured in any way.

Thus, one or more examples of the present disclosure provides a means for providing a parking system to optimize a parking process of parking one or more vehicles by marshaling the one or more vehicles to park in a particular location and in a particular orientation with the particular location based on one or more considerations as is described herein.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
assigning one or more vehicles to a zone within one or more geofenced locations based on a first set of inputs and a map of an area that includes the one or more geofenced locations;
assigning a target orientation within the zone to each vehicle of the one or more vehicles based on a second set of inputs; and
causing each vehicle of the one or more vehicles to move to a first target location within the zone, and to be positioned in the target orientation within the first target location.

2. The method of claim 1, further comprising:
identifying the one or more geofenced locations based on one or more locations of interest proximate the one or more geofenced locations, wherein the one or more locations of interest includes a repair bay, a transportation area, an inspection area, an assembly area, a short-term parking area, a long-term parking area, a purchase area, a calibration area, a testing area, or a combination thereof.

3. The method of claim 1, wherein the second set of inputs includes at least one of an expected interaction with each vehicle of the one or more vehicles, one or more serviceable components of each vehicle of the one or more vehicles, a wheelbase of each vehicle of the one or more vehicles, a turn radius of each vehicle of the one or more vehicles, steering capabilities of each vehicle of the one or more vehicles, the target orientation, or a combination thereof.

4. The method of claim 1, wherein the first set of inputs includes at least one of a vehicle status, a second target location, one or more vehicle characteristics, a likelihood of the one or more vehicles being damaged, a likelihood of the one or more vehicles being stolen, logistical delivery information for each of the one or more vehicles, or a combination thereof.

5. The method of claim 4, wherein the vehicle status indicates one or more tasks associated with an assembly of the vehicle, wherein the one or more tasks includes a vehicle repair, a vehicle inspection, a feature calibration, a sensor calibration, an additional component installation, or a combination thereof.

6. The method of claim 5, further comprising:
causing a vehicle of the one or more vehicles to move to the second target location, wherein the second target location is determined based on a dynamic order associated with when the one or more tasks are to be performed on each of the one or more vehicles.

7. The method of claim 5, wherein the assignment of the one or more vehicles to the zone is further based on:
determining a priority list of the vehicle repair associated with each vehicle of the one or more vehicles; or
determining a priority list of the logistical delivery information.

8. A system comprising:
a vehicle system configured to:
assign one or more vehicles to a zone within one or more geofenced locations based on a first set of inputs and a map of an area that includes the one or more geofenced locations,
assign a target orientation within the zone to each vehicle of the one or more vehicles based on a second set of inputs, and
cause each vehicle of the one or more vehicles to move to a first target location within the zone, and to be positioned in the target orientation within the first target location; and
the one or more vehicles configured to:
receive a first set of instructions, from the vehicle system, wherein the first set of instructions cause each vehicle of the one or more vehicles to move to the first target location, and
receive a second set of instructions, from the vehicle system, wherein the second set of instructions cause each vehicle of the one or more vehicles to be positioned in the target orientation within the first target location.

9. The system of claim 8, wherein the vehicle system is further configured to:
identify the one or more geofenced locations based on one or more locations of interest proximate the one or more geofenced locations, wherein the one or more locations of interest includes a repair bay, a transportation area, an inspection area, an assembly area, a short-term parking area, a long-term parking area, a purchase area, a calibration area, a testing area, or a combination thereof.

10. The system of claim 8, wherein the second set of inputs includes at least one of an expected interaction with each vehicle of the one or more vehicles, one or more serviceable components of each vehicle of the one or more vehicles, a wheelbase of each vehicle of the one or more vehicles, a turn radius of each vehicle of the one or more vehicles, steering capabilities of each vehicle of the one or more vehicles, the target orientation, or a combination thereof.

11. The system of claim 8, wherein the first set of inputs includes at least one of a vehicle status, a second target location, one or more vehicle characteristics, a likelihood of the one or more vehicles being damaged, a likelihood of the one or more vehicles being stolen, logistical delivery information for each of the one or more vehicles, or a combination thereof.

12. The system of claim 11, wherein the vehicle status indicates one or more tasks associated with an assembly of the vehicle, wherein the one or more tasks includes a vehicle repair, a vehicle inspection, a feature calibration, a sensor calibration, an additional component installation, or a combination thereof.

13. The system of claim 12, wherein the vehicle system is further configured to:
cause a vehicle of the one or more vehicles to move to the second target location, wherein the second target location is determined based on a dynamic order associated with when the one or more tasks are to be performed on each of the one or more vehicles.

14. The system of claim 12, wherein the vehicle system configured to assign the one or more vehicles to the zone is further configured to:
determine a priority list of the vehicle repair associated with each vehicle of the one or more vehicles; or
determine a priority list of the logistical delivery information.

15. One or more non-transitory computer-readable media storing processor-executable instructions that, when executed by at least one processor, cause the at least one processor to:
assign one or more vehicles to a zone within one or more geofenced locations based on a first set of inputs and a map of an area that includes the one or more geofenced locations;
assign a target orientation within the zone to each vehicle of the one or more vehicles based on a second set of inputs; and
cause each vehicle of the one or more vehicles to move to a first target location within the zone, and to be positioned in the target orientation within the first target location.

16. The one or more non-transitory computer-readable media of claim 15, wherein the at least one processor is further caused to:
identify the one or more geofenced locations based on one or more locations of interest proximate the one or more geofenced locations, wherein the one or more locations of interest includes a repair bay, a transportation area, an inspection area, an assembly area, a short-term parking area, a long-term parking area, a purchase area, a calibration area, a testing area, or a combination thereof.

17. The one or more non-transitory computer-readable media of claim 15, wherein the second set of inputs includes at least one of an expected interaction with each vehicle of the one or more vehicles, one or more serviceable components of each vehicle of the one or more vehicles, a wheelbase of each vehicle of the one or more vehicles, a turn radius of each vehicle of the one or more vehicles, steering capabilities of each vehicle of the one or more vehicles, the target orientation, or a combination thereof.

18. The one or more non-transitory computer-readable media of claim 15, wherein the first set of inputs includes at least one of a vehicle status, a second target location, one or more vehicle characteristics, a likelihood of the one or more vehicles being damaged, a likelihood of the one or more vehicles being stolen, logistical delivery information for each of the one or more vehicles, or a combination thereof.

19. The one or more non-transitory computer-readable media of claim 18, wherein the vehicle status indicates one or more tasks associated with an assembly of the vehicle, wherein the one or more tasks includes a vehicle repair, a vehicle inspection, a feature calibration, a sensor calibration, an additional component installation, or a combination thereof.

20. The one or more non-transitory computer-readable media of claim 19, wherein the at least one processor is further caused to:
cause a vehicle of the one or more vehicles to move to the second target location, wherein the second target location is determined based on a dynamic order associated with when the one or more tasks are to be performed on each of the one or more vehicles.
